(19) United States
(12) Patent Application Publication
(10) Pub. No.: US 2012/0290926 A1
(43) Pub. Date: Nov. 15, 2012

(54) EFFICIENT DOCUMENT MANAGEMENT AND SEARCH

(75) Inventors: Yogen Sudhakar Kapadia, Sunnyvale, CA (US); Vamshidhar Reddy, Seattle, WA (US)

(73) Assignee: INFINOTE CORPORATION, Sunnyvale, CA (US)

(21) Appl. No.: 13/466,003

(22) Filed: May 7, 2012

Related U.S. Application Data
(60) Provisional application No. 61/485,551, filed on May 12, 2011.
(60) Provisional application No. 61/584,756, filed on Jan. 9, 2012.

(51) Int. Cl. G06F 17/30; G06F 17/24; G06F 3/048

(52) U.S. Cl. 715/255; 707/758; 715/781; 707/E17.008

(57) ABSTRACT

Media content is parsed and content units of the media content are separated from its presentation data. The content units can be stored in a separate repository, such as a database, or repositories, such as with cloud storage, from where the content can be shared across various other electronic documents or other media contents. The content sections or “units,” are replaced within the media content or electronic document by references to the content in the content repository or repositories. The modified media content or electronic document with references can be stored in a separate section of the content repository or repositories or a different repository. To render the media content when requested or in response to a request by a user, the content and presentation information of the media content can be retrieved from their respective repositories and media content is synthesized, or otherwise put together.

### CROSS-REFERENCE TO RELATED APPLICATIONS

The present application claims priority to U.S. Provisional Patent Application Ser. No. 61/485,551, entitled “EFFICIENT DOCUMENT MANAGEMENT AND SEARCH,” filed on May 12, 2011, and U.S. Provisional Patent Application Ser. No. 61/584,756, entitled “EFFICIENT DOCUMENT MANAGEMENT AND SEARCH,” filed on Jan. 9, 2012, each of which are hereby incorporated by reference.

### TECHNICAL FIELD

This application relates generally to efficient document management and corresponding search of documents, and to various scenarios based on the efficient document management and search.

### BACKGROUND

By way of background regarding conventional systems, conventionally, Electronic Document Management Systems (EDMSs) have stored electronic documents in a source format (example, Microsoft Word) in a directory or folder containing other electronic documents. These documents may be eventually rendered in a format different from the source format (such as portable document format (PDF)).

Conventionally, the content of each electronic document has been independent of the content in other documents, i.e., separate document, separate content. If a line or a paragraph or a section from one (source) document needs to be included in another (target) document, both documents need to be opened, and the line (or paragraph, or section) from the source document needs to be copied to an intermediate memory for further copy, e.g., ‘copied and pasted’, to the target document. At this point, the target document has its own independent copy of the content with respect to the source document, which it maintains without relationship to the source document. For instance, changes made to the duplicated content in the target document have no impact on the similar content in the source document and vice versa.

Further, since content of each document is independent of the other, there is no precise way of knowing exactly how many documents share a given paragraph or a section, without a resource and time intensive, exhaustive search. Moreover, conventionally, even if the number of documents that share a given line, paragraph or section were known, if this line or paragraph or section needs to be updated, such line or paragraph or section needs to be updated individually across all the relevant documents. If there are 100 documents for update, 100 documents would need to be opened, the line, paragraph or section would have to be found within the 100 different documents (the location might not be the same), and the change would need to be effected in the 100 different documents separately.

Similarly, when a new document is created and if it has content that may have been already created in another document, the author has to recall about where the content may have been originally created or perform a search within the document management system and try to determine the relevant document from several results, an imprecise process that relies on author recollection of the authored document without assistance. The longer it has been since authoring, or if the new document author is different than the other document author with the similar content, the more that such difficulties are realized.

The above-described deficiencies of today's document and electronic management systems are merely intended to provide an overview of some of the problems of conventional systems, and are not intended to be exhaustive. Other problems with the state of the art and corresponding aspects of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, an electronic document is parsed and content of the electronic document is separated from its presentation data. The content can be stored in a separate repository, such as a database, or repositories, such as with cloud storage, from where the content can be shared across various other electronic documents. The content sections, or “units”, are replaced within the electronic document by references to the content in the content repository or repositories. The modified electronic document with the references can be stored in a separate section of the content repository or repositories or a different repository. To render the document when requested or in response to a request by a user, the content and presentation information of documents can be retrieved from their respective repositories and the document is synthesized, or otherwise put together.

In an example embodiment, a system comprises a memory that stores computer-executable components, and a processor, communicatively coupled to the memory, that facilitates execution of the computer-executable components. The computer-executable components include a suggestion component configured to, in response to reception of a user input that includes a set of first content units of a first document, present a set of second content units that are related to the set of first content units based on a set of predetermined criteria and are at least a part of a set of second documents different from the first document. The system further includes a parsing component configured to parse the set of first content units, and determine the set of second content units that relate to the set of first content units based on a first content unit of the set of first content units satisfying at least one of the predetermined criteria.

In another exemplary embodiment, a system comprises a memory that stores computer-executable components, and a processor, communicatively coupled to the memory, that facilitates execution of the computer-executable components. The components comprise a view component that comprises a first view area configured to create or edit a first document having first content units. The system also comprises a second view area configured to present second content units dynamically from one or more second documents different from the first document in response to the first content units being created or edited for the first document in the first view area. A modification component is configured to receive a modification input that selects which of the first document or the one or more second documents to modify, and to modify at least one selected document of the first document and the one or more second documents based on the first content units or the second content units.

In yet another exemplary embodiment, a method comprises receiving, by a system including at least one processor, a set of first content units of a first media content input to the system via a user interface. The method further comprises presenting, in response to the receiving the set of first content units, a set of second content units of a set of second media content different than the first media content that are related to the set of first content units based on a set of predetermined criteria and are at least a part of second media content stored in at least one memory. The method comprises parsing the set of first content units of the first media content is parsed. The method further comprises determining the set of second content units that relate to the set of first content units is determined, which includes determining first content units of the set of first content units satisfying at least one of the predetermined criteria.

In yet another exemplary embodiment, a computer readable storage medium comprises computer executable instructions that, in response to execution, cause a computing system including at least one processor to perform operations. The operations comprise parsing a set of second documents to determine a set of corresponding sections in the set of second documents that relate to content units from a first section of a first document, and modifying at least one or more documents of set of documents and the first document with at least one corresponding section of the set of corresponding sections by a single user input.

In still another exemplary embodiment, a system comprises means for creating or editing a first document including means for presenting at least respective parts of content units from a set of second documents that relate to a content unit being generated or edited for the first document; and means for sharing selected content units between at least the respective parts of the content units and the first document.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary system for managing media content in accordance with various embodiments described.

FIG. 2 illustrates an exemplary system for managing media content in accordance with various embodiments described.

FIG. 3 illustrates an exemplary system for managing media content in accordance with various embodiments described.

FIG. 4 illustrates an exemplary system for managing media content in accordance with various embodiments described.

FIG. 5 illustrates an exemplary data model of the system having the functionality of separating content from presentation of documents and ability to share content across multiple documents.

FIG. 6 illustrates an exemplary page for adding a new document or editing an existing document in the system.

FIG. 7 illustrates an exemplary page or screen of how the approach depicted in FIG. 6 can be extended to any form used for adding, editing or viewing content in the system.

FIG. 8 illustrates an exemplary way of showing the version history of a document in the system.

FIG. 9 illustrates an exemplary way of showing the version history of a unit (element) of content in the system.

FIG. 10 illustrates an exemplary search page displaying precise search results for documents matching the words searched in the system.

FIG. 11 illustrates an exemplary search page displaying precise search results for units of content matching the words searched in the system.

FIG. 12 illustrates an exemplary page for adding and updating a unit of content in the system and pushing the update to the impacted documents.

FIG. 13 illustrates a method of managing documents in accordance with various aspects described herein.

FIG. 14 illustrates another method of managing documents in accordance with various aspects described herein.

FIG. 15 is a block diagram representing exemplary non-limiting networked environments in which various embodiments described herein can be implemented.

FIG. 16 is a block diagram representing an exemplary non-limiting computing system or operating environment in which one or more aspects of various embodiments described herein can be implemented.

### DETAILED DESCRIPTION

### Overview

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. Additionally, the word “set” or “sub-set” is used herein to refer to one or more of a component or item in which the term modifies or refers to.

As mentioned, in one or more embodiments, an electronic document is parsed and content of the electronic document is separated from its presentation data. The content can be stored in a separate repository, such as a database, where it can be shared across various other electronic documents. The content sections are replaced within the electronic document by references to the content in the content repository mentioned above. The modified electronic document can be stored in a separate section of the content repository or a different repository. To render the document when requested or in response to a request by a user, the content and presentation information of documents can be retrieved from their respective repositories and the document is synthesized, or otherwise put together according to its constituent parts.

As an overview the various embodiments of efficient document management, the various embodiments herein include methods that can apply any of the following operations or processes: separating content from its presentation, sharing the content across various documents without requiring the content to be duplicated, and regenerating the document on demand by putting its content and presentation information together; updating a unit of content and pushing or otherwise automatically sending the updates to all or selected documents that share the same unit of content; providing precision (exact) search results for documents and units without extraneous documents; real-time assisting of creation of documents by searching the library for existing units of content and allowing the library results to be incorporated in one or more (e.g., two) of the documents, such as by dragging and dropping or double-clicking the selected unit of content; representing document genealogy precisely showing exactly what units changed across various versions; or representing unit genealogy showing exactly what documents changed across various versions. A content unit referred to herein includes a section, a paragraph, a sentence, at least one or more words, a word, a heading, and/or a portion of media content.

These methods can also be extended beyond the context of EDMS to the context of Social/professional networks for doctors/lawyers for sharing and extracting content from their own library and also from the peer network for reuse. With respect to re-use, an option for reimbursement on use can be implemented and/or an option for ranking content based on use can be implemented.

An apparatus for accessing, implementing or benefiting from the various embodiments can include a memory having computer executable components stored thereon, and a processor communicatively coupled to the memory, where the processor is configured to execute the computer executable components, the computer executable components configured to provide a variety of respective abilities, or their sub-combinations or supersets, including: the ability to separate content from its presentation, share the content across various documents without requiring it to be duplicated, and regenerate the document on demand by putting its content and presentation information together, the ability to update a unit of content and push the updates to all or selected documents that share the same unit of content, the provision of accurate and precise search results for documents and units, real time assistance in creating documents by searching the library for existing units of content and allowing these to be incorporated easily in to the document by either dragging and dropping or double-clicking the selected unit of content, provision or render of a precise and accurate representation of document genealogy showing exactly what units changed across various versions, provision or render of a precise and accurate representation of unit genealogy showing exactly what documents changed across various versions.

This platform can be extended beyond EDMS to creating Social/professional networks for doctors/lawyers where they can share and extract content from their own library and also from the peer network for reuse with an option for reimbursement on use and ranking content based on use. In other embodiments, a computer-readable storage medium comprising computer-readable instructions that, in response to execution by a computing system, cause the computing device to perform according to one or more of the above sets or subsets of abilities.

### Efficient Document Management and Search

In the following detailed description, reference will be made to the accompanying drawing(s), in which identical functional elements are designated with like numerals. The aforementioned accompanying drawings show by vary of illustration, and not by vary of limitation, specific embodiments and implementations consistent with principles of the present invention. These implementations are described in sufficient detail to enable those skilled in the art to practice the invention and it is to be understood other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of specialized hardware, or combination of both software and hardware.

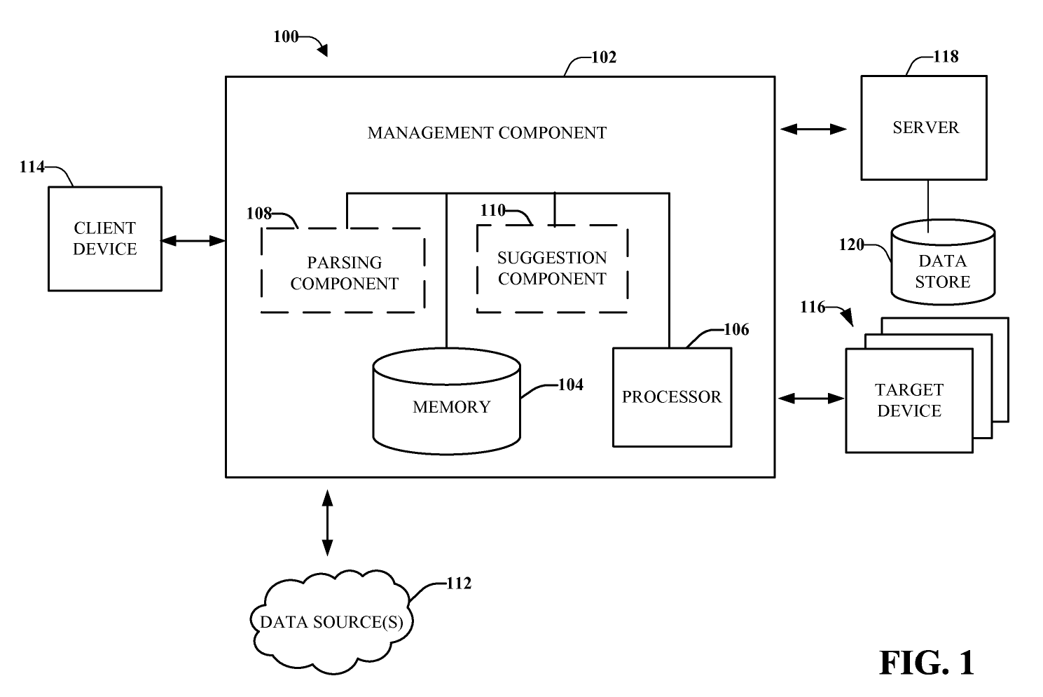

FIG. 1 illustrates a management system 100 that parses media content such as documents, images, graphical symbols, and the like, and is operable to present units of media content (e.g., content units) from one media content to other media content. Media content is used herein to include audio, video, graphical, textual, and symbolic imagery. Although the example embodiments and aspects related to the examples may be described in relation to a document for ease of description, the example embodiments described herein can include any type of media such as video, audio, captured images, any combination of video, audio and graphical images, and the like. In addition, the term content unit is intended to describe a unit of content from media content, such as a section, paragraph, sentence, one or more words and/or a title in a textual document, a portion of video and/or a graphical image, for example.

The system 100 comprises a management component 102 that communicates with various devices, servers, and/or data sources to parse data within media content that is stored and/or being generated. The management component 102 can be located in any one device, server and/or data source and/or external thereto. For example, the management component can be communicatively connected with a client device 114 and/or a target device 116, in which both can include a mobile phone, personal digital assistant (PDA), laptop, personal computer, any combination and the like. In addition, the management component 102 can be communicatively connected to a server 118 and/or data source(s) 112. The data source 112 can be a cloud infrastructure that enables access to data storage, for example.

The management component 102 is able to access and parse a set of media content that includes libraries, files, documents, and content units thereof from a memory 104, the data sources 112, the client device 114, a target device 116, and the server 118 having a data store 120, as well as other management components or set of data stores in communication with the management component 102. The content units can be stored in the memory 104, or elsewhere, such as in a separate repository, such as a database, where it can be shared across various other types of media content (e.g., documents). For example, the management component 102 shares the content units stored among various media content, and also with media content being generated. For example, a document can be created through user input that includes a set of first content units, such as digital text. Concurrent with the generation of the content units in the documents, the management component 102 is operable to suggest, present, and/or generate a set of second content units (e.g., textual portions) from other documents that can be stored in the memory 104, the data sources 112, client device 114, target device 116, the server 118, the data store 120, and like sources. In response, each set of content units that is presented or all of the set of first content units can be modified by the management component 102 to be uniform, conform to, or made substantially the same as any one of the set of second content units Likewise, the management component 102 is operable to modify any number of the set of second content units with the set of first content units generated in the document. This enables a substantial cost savings within industries endeavoring to keep records, files, reports, documents, templates, etc. up-to-date and compliant with one another without having to manually modify and organize each section of a media content, multiple forms of media content, and multiple versions to make them compatible with one another.

The management component includes a processor 106 operatively coupled to a parsing component 108 and a suggestion component 110. The parsing component 108 is configured to parse a set of first content units, such as sections, paragraphs, pages, titles, or any portion of a document or content media that are being generated or already stored in a memory. For example, a paragraph can be parsed from the text of a document that is being created. In addition, sections of stored documents can also be parsed so that sections of the saved documents are referenced later.

In another embodiment, first content units of a first document can be determined by the suggestion component 110 to relate to a set of second content units of a set of second documents according a set of predetermined criteria. The set of predetermined criteria can include a match of at least one or more words of the set of second documents with at least a part of the set of first content units generated based on the user input, a match of content units of the set of second content units with at least the part of the set of first content units, a position of the set of first content units within the first document satisfying a condition, a context of the user input based on a determination of subject matter of the user input satisfying a condition, a match of a section title of the set of second documents with a section title of the set of first content units, a relevance score based on one or more of the set of predetermined criteria satisfying a condition, a frequency of reuse across different documents of the set of second documents satisfying a condition, a percentage of usage of at least the part of the set of first content units within the set of second documents satisfying a condition, or a match of metadata associated with the set of first content units with pre-defined metadata.

The parsing component 108 parses the content units from the document being created and also is configured to determine a set of second content units that relate to the set of first content units. The set of second content units, for example, can relate to the set of first content units based on the first content units matching with at least a part of the set of second content units in different documents. For example, a user generates a section of a document by typing text and the parsing component 108 analyzes the text or tokens of the documents being generated in order to determine grammatical structure, words being used, and/or syntax of the words based on a set of rules. The parsing component 108 then determines second content units from other documents or media content that relate to the parsed first content generated by the user.

The parsing component is operatively connected to the suggestion component 110, which operates to generate, present, or suggest a set of second content units that relate to the first content units. For example, the system 100 can receive a user input that includes a set of first content units of a first document, such as a textual type with one or more words, a sentence, a paragraph, title, etc. In response to the reception of the user input, the suggestion component 110 presents a set of second content units that are related to the set of first content units based on a set of predetermined criteria and that are at least a part of a set of second documents.

The system 100 is operable to generate portions of other documents that are found to relate to a document being created. The system 100 separate or parses the content of the document being created and presents portions of other documents, for example, that a user can then easily insert into the document being generated. In addition or alternatively, the system 100 can receive a user input that selects among the other documents (e.g., set of second documents) and with a single click or other input, modify all selection sections to be uniform with the first content units being generated. The modified document being created can then be stored in a separate section of the content repository or a different repository, memory or data store of the data sources 112, client device 114, target device 116, server 118, memory 104, and/or elsewhere. In response to a user request any one of the documents that have been modified and/or created can be retrieved by their respective memories and the document is synthesized according to the modifications, or otherwise assembled according to its constituent parts.

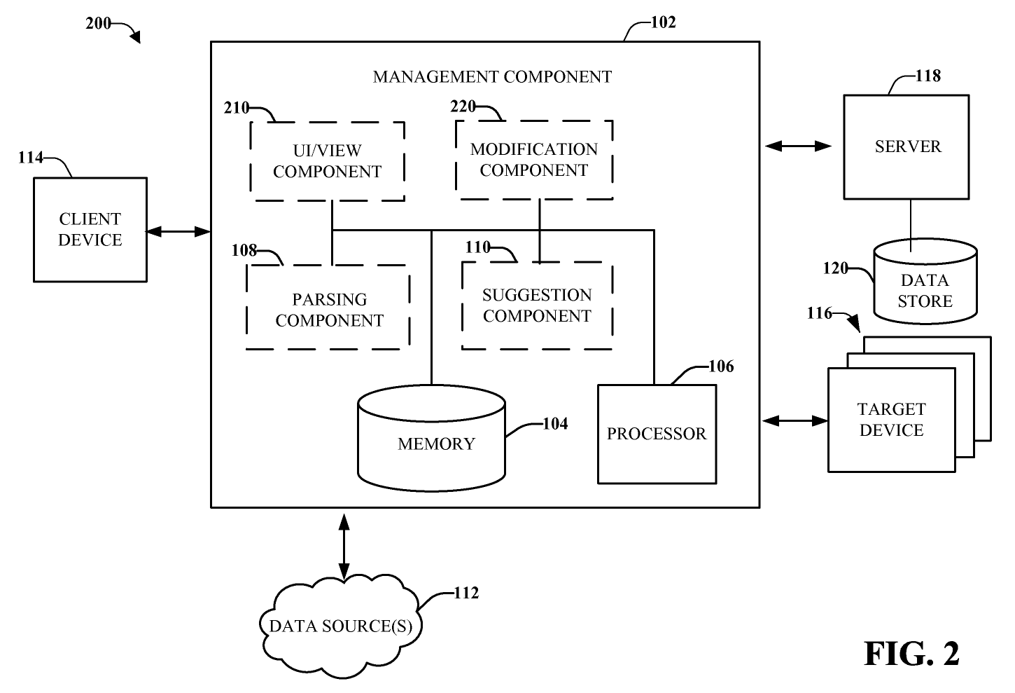

Referring now to FIG. 2, illustrated is an exemplary system 200 that manages media content, such as content of one or more documents, across various volumes of memory, devices, and/or communication connections. The system 200 parses and separates content from its presentation, such as from a user typing a document in a user display view of a data source 112, a client device 116, a target device and/or a server or other data storage component, such as the data store 120 or some other separate component memory (e.g., an external drive, and the like). The system 200 is operable then to share or modify content across various documents without requiring the content to be duplicated or otherwise stored.

For example, a user can type a sentence pertaining to safety protocols, and the system 200 provides similar sections, paragraphs, sentences, titles, headings, and the like from other documents based on a set of predetermined criteria. A user is able to copy and paste those portions by dragging, clicking or some other input to insert a selected portion from the other documents. In addition or alternatively, the system receives a selection input indicating which documents from among the set of second documents to modify. Based on the selection, the system 200 modifies each document selected with the set of first content in order to make all of the selected document portions substantially the same, substantially alike, or similar to the first content.

For example, the system 200 includes user interface component or otherwise a view component 210, a modification component 220, the memory 104, the processor 106, the parsing component and the suggestion component 110. The view component 210 generates a document view that operates in conjunction with a document creation, such as .doc, .pdf, and the like. For example, a user display view (not shown) having a first view area and a second view area. The first view can be generated for a user to create, type, or generate content units of a first document and a second view area to present one or more portions or content units of second documents or second documents that have content units related to the first content units. The view component 210 enables presentation of the second content units dynamically in response to the first content units being generated for the first document. The view component 210 enables a modification input to be received that selects which content units to modify or reference when selected documents are presented to a user.

The modification component 220 receives modification input from the view component 210 that selects which documents from among the first document being created and a set of second documents to modify. For example, the user can select to modify the document being created (e.g., a first document) with content units from any one or more second documents that are determined via the suggestion component 110 to relate to the content units of the first document. Thus, portions of or an entire document can be created with portions of other documents (e.g., words, sentences, paragraphs, sections, etc.).

Alternatively, the user can select to modify any one of the second documents with content units being generated for the first document. For example, a user could create a paragraph that relates to a safety protocol to be used within a set of safety guidelines for a distribution across a corporation. Rather than having to update each document throughout all databases with the newly created safety protocol paragraph, the user can select which documents to be updated and enable the new paragraph to be incorporated throughout all the related documents selected. The modification component 220 is further configured to modify the selected document or documents based on the modification input received.

In one aspect, the modification component 220 generates updates within each of the selected documents so that the set of second content units and the set of first content units are substantially alike, similar, or equal. Upon rendering the selected documents thereafter, the selected documents are presented with the newly created first content units (e.g., a paragraph with one or more sentences of words) of the first document. The first document can be saved or not, whereas the second documents to be updated are stored in a repository, system memory, or any data store coupled to the system 200. In one embodiment, content units of the first document being created are replaced within the second documents stored by references to the first document, which is thus stored in the same or a separate memory as the second documents. Any of the second documents that have been updated or modified are then able to be rendered by any user with the new version having the newly updated portions or content units that derived from the first set of content units.

In one embodiment, the content units of one or more documents is modified by the modification component 220 independently of duplicating any portions, sections, or otherwise content units of any of the documents determined as being related or selected. For example, a document selected can be referenced or tagged with metadata of a desired portion so that upon rendering of the document, the portion or section that is referenced or tagged is generated with a newly modified set of content units along with any other content units of the document that were stored with the document. The system 200 is therefore able to modify documents without duplicating the modified content units. For example, a tagged portion of a document referencing another portion in another document enables the document to be rendered with the updated, tagged portion. Therefore, both documents can include substantially equal data (e.g., content units) at both portions, in which the portions include words, sentences, paragraphs, sections, titles and the like portions of a document without duplicating the data or content units of either document.

In one embodiment, the presented portions or set of second content units can be presentation of a part of the one or more content units from a second document, such as a sentence, or a few words that are part of the set of second content units. The view component 210 is further operable to display all of each of the set of second contents in response to a user's input and enable selections to be received for modifying a document being generated with the set of second contents and/or modify the set of second contents with first content units being generated or selected. For example, a viewing space can be conserved where multiple sets of second content units from the set of second documents are generated in response to similar first content units of a first document being generated or selected in a view are thereat.

The view component 210 with the suggestion component 110 is operable to alter in real time the set of second content unit being presented in response to a modification of the set of first content units for a first document. For example, a user generates typed content that includes content units or sections of the document. As the user types, sections from other second documents that have been parsed are displayed within a view area according to the predetermined criteria discussed above. Thus, the suggestions viewed by a user that relate to the first content units being generated can alter dynamically according to the content units. Alternatively or additionally, a content units from a document already generated or stored can be selected and related content units displayed could be displayed and modified as content units are added. Thus, the suggestion component 110 and the view component 220 maintain or increase in precisions as content is modified manually by a user.

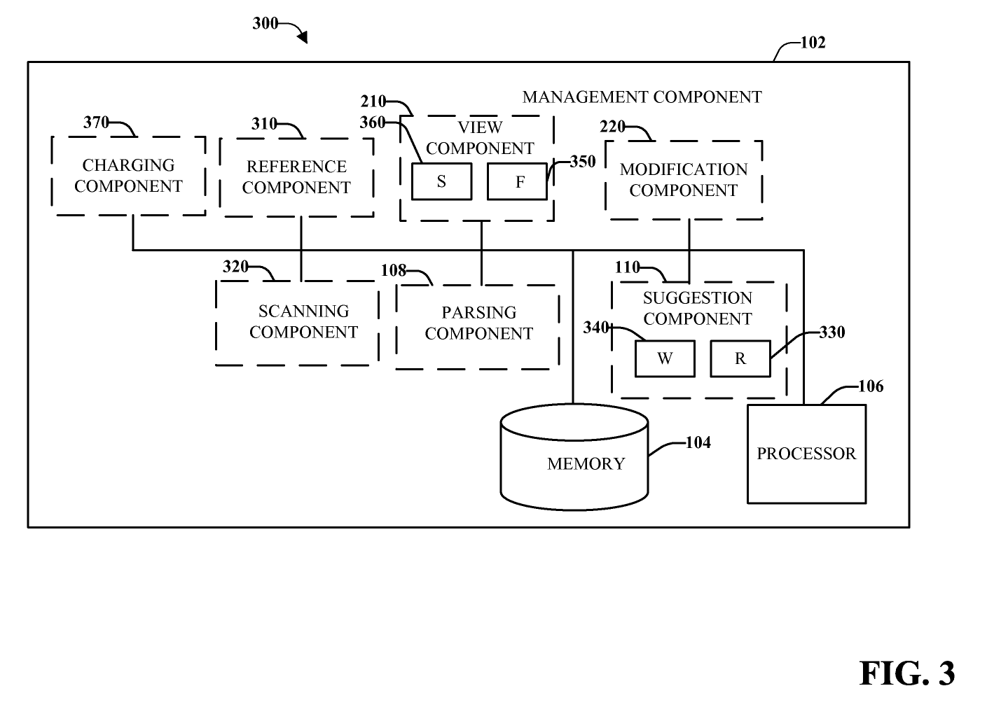

FIG. 3 illustrates a system 300 that includes the management component 102 that manages media content (e.g., digital documents, images, audio, video) to update various portions or sections of the media content based on portions or sections (content units) of other stored media content. The system 300 parses and separates content from its presentation, such as from a user typing a document or a selected set of content units (e.g., a section of a document with content units) in a user display view. The system 300 is operable to share or modify content units of one document across various documents other documents, for example. The sharing or modifying is performed in one example independently the content units or portions of content being duplicated or otherwise stored.

The system 300 comprises the management component 102 including a reference component 310 and a scanning component 320. Additionally, the management component 102 includes the memory 104, the processor 106, the parsing component 108, the view component 210, and the modification component 220. The suggestion component 110 includes a weighting component 330 and a rating component 340. The view component includes a first view area component 350 and a second view area component 360.

The first view area component is configured to generate a first view area that is configured to create or edit the first document having the set of first content units. The second view area component 360 is configured to generate a second view area configured to present the set of second content units from the set of second documents different from the first document in response to the first content units being created or edited for the first document in the first view area. The second view area presents the set of second content units that are related to the set of first content units based on the set of predetermined criteria, discussed herein, and include at least a part of a set of second documents different from the first document. For example, the set of second content units presented include paragraphs of the set of second documents. The set of second documents can be different from one another with other content units.

Additionally, the user interface component or viewing component 210 is configured to receive input on at least one subset of second content units of the set of second content units and in response to the input generates a list of documents that have the at least one subset of second content units and a list of actions to perform to documents of the list of documents. The list of actions can include propagating user input to content units on all documents of the list of documents or to a subset of the list of documents. These actions can be performed according to the predetermined criteria and user settings, for example.

For example, a user can type in XYZ as content units (e.g., words, sentences, paragraphs, headings, etc.), and similar or same content units from other documents can be returned to the user (e.g., XYZ, X′YZ, XY′Z″). Then a user can select, for example, X′YZ″ and then the second view presents a list of only those documents with X′YZ″.

The reference component 310 operates to generate references to different portions, sections or otherwise content units of a media content (e.g., a document, video and the like) with other portions, sections or otherwise content units of a different or second media content. For example, the referencing component 310 is operable to identify audit trails or different versions of the set of content units and record the different versions of the set of content units with a tag or with metadata comprised in a reference. For example, a set of content units can be one or more words, sentences, paragraphs, sections, heading or titles of a document that are different from another set of content units. When a set of content units from a different document is changed with content units from a first document, the reference component 310 references one set of content units with the other set of different content units.

In one embodiment, the set of second content units that are at least a part of the set of second documents can be presented by the suggestion component 110 with a reference to a storage location of the respective second content units of the set of second content units, in which the reference or tag includes the respective storage location. As such, the second content units of the set of second documents are parsed by the suggestion component 110 before the suggestion component parses the set of first content units. In other words, the set of second documents are pre-parsed and indexed by the parsing component before the suggestion component 110 parses the set of first content units

In another embodiment, the modification component 220 and the view component 210 operate with the reference component 310 to render a document that has been modified based on the references that have been generated. To render a document when requested or in response to a request by a user, the content units of modified document and presentation data of documents can be retrieved from their respective repositories and the document is synthesized or otherwise pieced together according to the references or tags therein. For example, the modification component 220 is configured to modify the presentation of the each portion or set of content units according to the references or tags at each portions or set of content units within a document being rendered.

In another embodiment, each tag or reference includes a genealogy of changes to content units of a first document and/or a set of second documents. For example, a user can be presented via the suggestion component 110 different sets of content units from other documents based on content provided, selected or generated in a first view from a first view component 350 of the view component 210. The system can receive a modification input that selects all or a portion of the content units suggested or presented within a second view 360 of the view component 210. In response to the selection, the reference component 310 can provide references to portions or content units within each document selected for modification. The references reference the set of content units that are selected from in a first document that the second selected documents are to be modified with. In addition, the first document can be created from portions or sets of content units of the second units. Thus, rather than modifying the second documents with content units in the first view area 350, content units in the second view area 360 can be used to modify content units in the first view area 350 to create documents from references via the reference component and not just update existing documents or media content.

Additionally, the reference component 310 generates tags or references that can include a genealogy of changes to documents, where each tag or reference is operable to link to different portions or updates generated along the lifespan of a modified or created document. Alternatively, the tag or references are indicators of a version history or properties of the modified documents or portions of the documents.

As discussed above, the view component 210 includes the first view area component 350 that is configured to create a first document including first content units, and a second view area component 360 that presents second content units from one or more second documents dynamically in response to the first content units being generated for the first document in the first view area. The content units presented can include a part of paragraphs from one or more second documents. The parts of paragraphs relate to the first content units in the first view area. Both content units of the first view area via the first view component 350 and the second view are area of the second view component 360 include one or more digital images, words, number, characters and/or symbols.

The modification component 220 is configured to receive modification input that selects which of the first document and the one or more second documents to modify. In one embodiment, the modification component further modifies any number of selected documents that are from the first document and/or the second documents based on either the first content units of the first view area or the second content units of the second view area. For example, a user can select any one of the set of content units, such as content units of a second document that is suggested by the suggestion component 110 and modify a document portion in the first view area that is being created as well as also modify other selected documents of the set of second documents, in which the selected second document portion includes the content units utilized for updating all the documents selected in the modification input.

The system 300 further includes a scanning component 320 that receives a scanned document and reads the scanned document with an optical recognition algorithm, such as optical character recognition or a like pattern recognition engine for recognizes characters, numbers and/or images. The scanning component 320 uses the analyzed content units as the first set of content units for view in the first view area generated by the first view area component 350. The scanned content can be used to further generate a document and by the suggestion component 110 to further suggest related sets of content units in which to modify or update across any number of other second documents that can be accessed by the system 300.

In one embodiment, the suggestion component 110 includes a rating component 330 that measures a relevancy score of the set of first or second content units. The parsing component 108 parses documents that are being generated and documents that are stored. The parsing component 108 determines content units that relate to the one another, such as what second content units relate to first content units of a first document that is being created. For example, first or second content units of a set of different documents can be parsed to determine those content units from among the different documents that match in order to modify, update, add or delete those sections in other documents or within the respective documents.

The suggestion component 110 operates to provide suggestions of content units in other documents in response to a user input reception that includes a set of first content units. The user input received can be any portion of an audio, a video, a scanned document, text of a document, images, and the like which make up portions of media content. The suggested portions or set of content units including one or more content units (e.g., two or more words) can be partially displayed initially and fully displayed upon receiving a user input (e.g., a mouse hovering over, a click, and other like inputs).

The content units are rated by the rating component 330, in which the ratings can be dynamically updated as more information is generated in the first view area of the first view area component 350 for a document or any media content creation. The rating component 330 is configured to measure a relevancy score of the set of content units according to at least one of the set of predetermined criteria. The set of predetermined criteria can include a match of at least one or more words (e.g., two) of the set of second documents with at least a part of the set of first content units generated based on the user input, a match of content units of the set of second content units with at least the part of the set of first content units, a position of the set of first content units within the first document satisfying a condition, a context of the user input based on a determination of subject matter of the user input satisfying a condition, a match of a section title of the set of second documents with a section title of the set of first content units, a relevance score based on one or more of the set of predetermined criteria satisfying a condition, a frequency of reuse across different documents of the set of second documents satisfying a condition, a percentage of usage of at least the part of the set of first content units within the set of second documents satisfying a condition, or a match of metadata associated with the set of first content units with pre-defined metadata. The suggested content units from various sections of documents can therefore be ranked according to their relevancy score by the rating component and sorted according to their rank.

The suggestion component 110 further includes a weighting component 340 that weighs each of the set of predetermined criteria according to a setting. The setting can be a user preference that sets one or more of the criteria to be weighted stronger than other sets of criteria. For example, a match of one or more content units or words of a document with content units of another document could be weighted higher when making suggestions. Additionally, any number of words within a paragraph having the same words as in another set of content units can be set by the setting. Therefore, the user can define the level of granularity in which the suggestion component 110 provides suggestions and ranks them to the user via the weighting component 340.

In another embodiment, the management system 300 can be extended with a pricing component 370 to Social/professional networks for doctors/lawyers where they can share and extract content from their own library, or for any group of individuals desiring to share writings or media content, such as from the peer network for reuse with an option for reimbursement on use and ranking content based on use via the rating component 330. Thus, an efficient means of sharing data, which may or may not be a registered copyright or a copyright can be utilized by sharing information content units across a number of documents or an entire network based on a charge or cost generated and received. For example, the pricing component 370 can generate a cost, either automatically or through user input control and receive payment related to an authorship, a number of the selected documents selected by a user or any number of criteria.

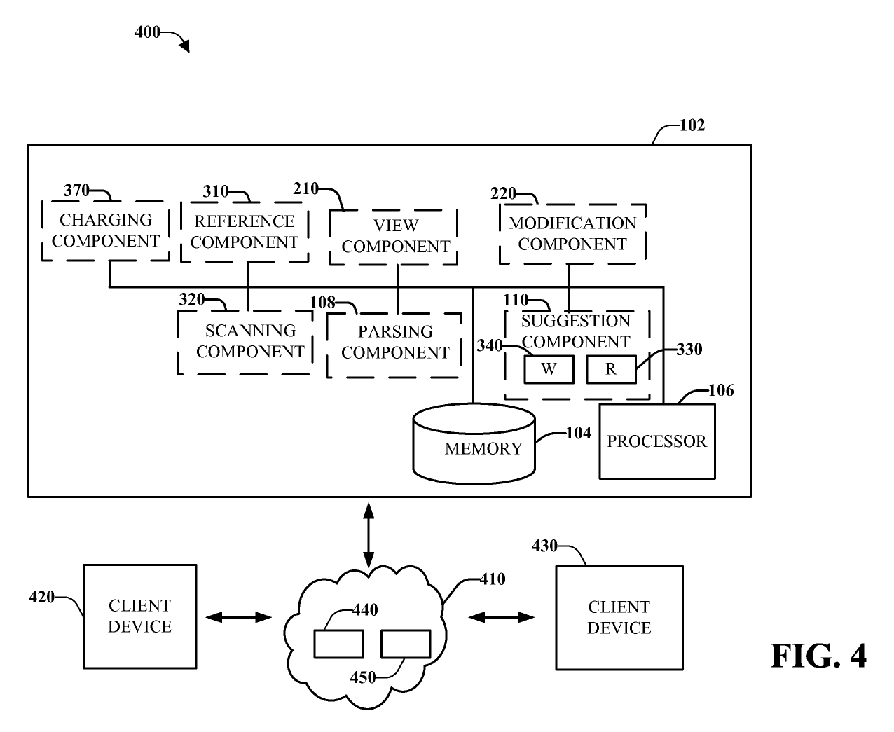

FIG. 4 illustrates an example embodiment of a system 400 that manages media content to enable updating, modifying, creating and referencing with one click or user input (e.g., click, touch, command, etc.) among multiple various content units or sections of media content. The management component 102, as discussed above, enables documents across various repositories, libraries and/or devices to uniformly update, modify, create and reference with other documents. The system 400 illustrates further that the the management system is operable as a cloud based system or any other system that managements volumes of media content across multiple repositories or data stores.

For example, the management component 102 can operate in a cloud network 410 that provides different repositories associated with different clients and/or different content units (e.g., first content units and second content units of different documents). A client device 420 can be allocated to a data store 440, while a client device 430 can be allocated to a different data store 450, which may or may not be shared with other clients or customer devices. In one example, client device 430 could have access to the repositories of client device 420 so that the pricing component 370 keeps track of the content sections (e.g., a paragraph, a section of a document, etc.) that may be under copyright protection within various documents or types of media content. The pricing component, for example, can keep track of content units that make up an entire document and/or sentences, paragraphs or portions of a document. The pricing component 370 then generates a cost to receive payment relates to authorship of the client 420 and the number of selected documents from data store 440 that client device 430 modifies other documents in data store 450.

In another example, client device 420 and the corresponding data store 440 can be completely separated from client device 430 and the data store 450 belonging thereto. Thus, enhanced security and protection is enabled among documents managed by the management component 102 for multiple client devices. Additionally, each client device 420 and 430 is able to easily move or share data across different cloud providers and/or within a respective local area network (LAN). For example, a customer can start using the management system 400 on a corporate existing IT infrastructure and then seamlessly move to a cloud, and vice versa.

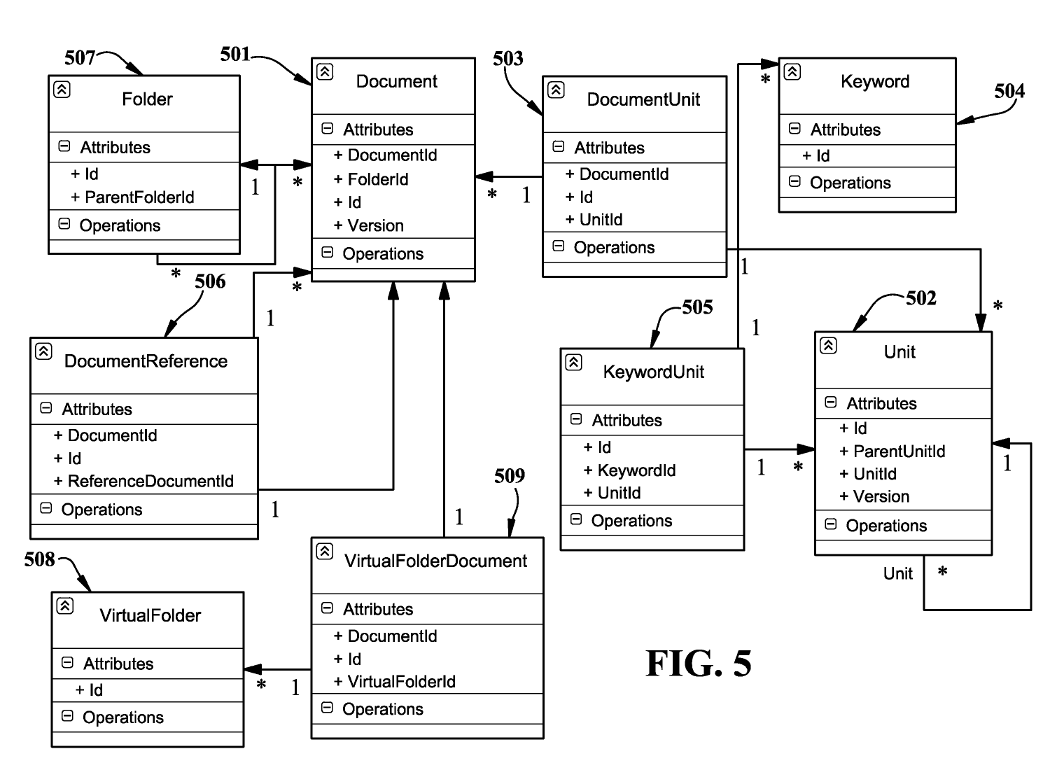

One aspect of the systems discussed above in FIGS. 1-4 is to separate content from a presentation, such as by referencing content from data being generated in real time or without the data being duplicated. In the case of documents, this involves but is not limited to extracting core content or content units and separating it from formatting and other supplementary information. FIG. 5 illustrates, for example, one possible way of storing content separately from presentation information and yet maintaining referencing to the original document(s). A document reference field or tag 501 illustrates some of the sub-fields and genealogies associated with storing data related to a document while a tag or reference 502 shows some of the metadata fields associated with storing content units or units of content within a document. A unit of content or set of content units can comprise, but is not limited to, a word, a sentence, a paragraph, a section or the entire document. A document unit field 503 links together document(s) with unit(s) of content, which illustrates the reference tags with metadata of a document section or set of content units of a document that have been referenced by the reference component 310 discussed above.

The systems discussed herein with respect to media content being managed by fields of reference, tags or reference tags 501, 502 and 503 can be extended to build additional elements such as, but not limited to:
1. Keywords associated with content via references or tags—an example of which is depicted by reference fields 504, 505, and 502.
2. Documents referenced by a given document as exemplified by reference tags 506, 501.
3. Folders being referenced in which the document is contained as exemplified by 507, 501.
4. Virtual folders that a document may be contained in—an example of which is shown in virtual folder references 508, 509, 501.

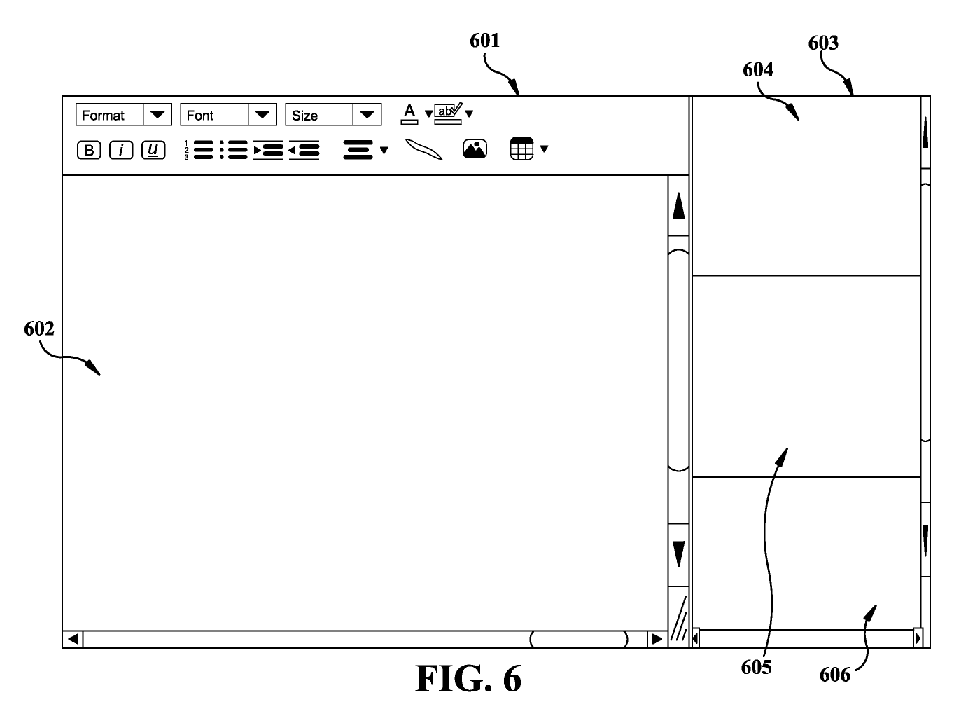

The systems discussed above in FIGS. 1-4 can also be used as a library of content that can share relevant pieces or units of content to expedite the creation and/or maintenance and/or editing of content. FIG. 6 illustrates an aspect of how an embodiment can be used to assist in creating a new document or editing any number of existing documents by sharing content units in one click or through a single input of a user. For example, as a user generates content (e.g., text or other media content) in a first view area (e.g., a rich-text editor) 602 generated by the first view area component 350, the system does a real time check with its library, aspects of which have been depicted in FIG. 5, and serves relevant content that may already exist based on matches found based on, but not limited to, keywords, content signatures, etc. For example, if a user starts typing “Safety Instructions” within the first view area 602, the suggestion component 110, in real time, finds matches for content units (e.g., paragraphs) relevant to “Safety Instructions” and displays them as exemplified by the frame or second view area 603 containing one or more sets of content units 604, 605, 606, in which each set of content units can be shown as a partial view of the words, sentence, and/or paragraph corresponding with the content of the document that the content units are found. A user input, such as hovering or the like can then allow all content to be displayed within the views.

Additionally, the user can rapidly include the entire unit of content from the second view area 603 into the first view area 602 by provide a user input action such single clicking, double-clicking, dragging, dropping and the like. This enables a fast document creation with paragraphs or sections with content units from other documents that the suggestion component 110 provides to a user. Likewise, a user can select the different sets of content units presented in the second view area 602 and make them all correspond, in which each set of content units and/or the content within the first view area being generate are uniformly similar, substantially alike, equal or in conformity with one another. The modification component 108 thus generates sections of content that are uniform or the same throughout all documents selected by the user without duplicating the referenced content selected to updated all other selected content units. For example, a user can chose the content in the first view area to update other selected content of other documents with, wherein the modification component 108 is configured to update, within each of the selected documents content units to be substantially alike with the first view area.

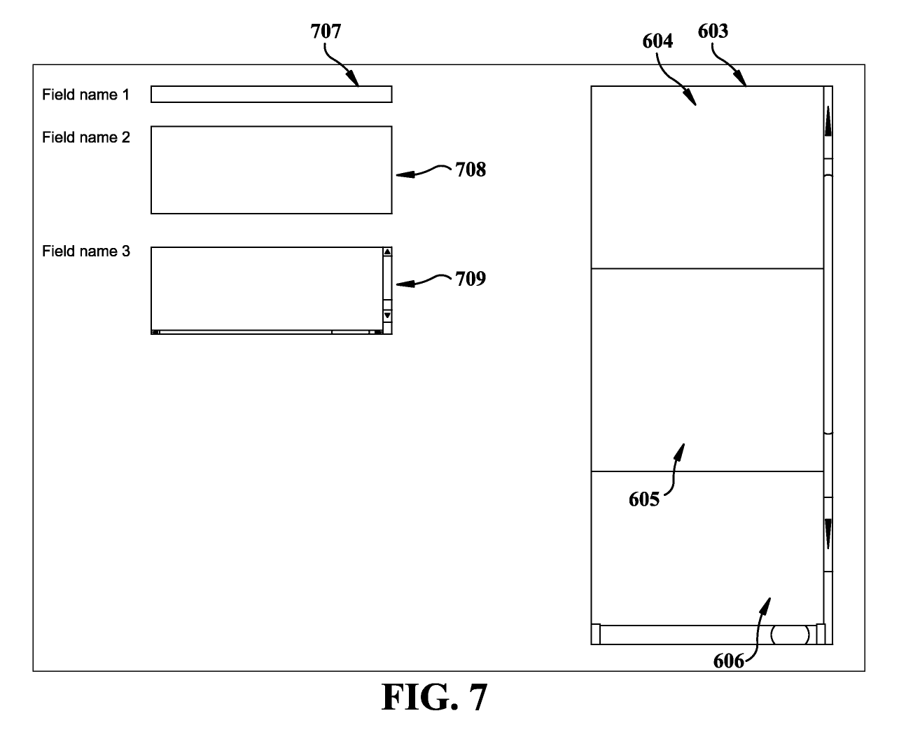

FIG. 7 exemplifies how the approach depicted in FIG. 6 can be extended to any form used for adding, editing, deleting or viewing content in the system. An example of such a system can be a medical record system where a medical practitioner enters the name of a disease in a field such as 707, 708, 709 and the system serves up relevant treatment(s) such as 604, 605, and 606 in the frame or second view area 603. The user (medical practitioner in this case) can rapidly include the entire units of content or selected content units from 603 in to 707, 708 or 709 by performing an action such double-clicking, dragging and dropping. In one embodiment, a user can name a section of content or mark it for easy search and retrieval, which enables the content units of a particular section to be easily recalled and updated across multiple documents or content units with the systems discussed.

The order and ranking of units of content via the ranking component 330 displayed in 603 can be based on aspects such as, but not limited to, keywords, semantics, frequency of use of a unit of content by various users, ranking of the author of the unit of content by the system, trust placed by the user in the author of the unit of content, proximity between the user and the author of the unit of content within a given social and/or professional network, geographical proximity between the user and the author of the unit of content. Further, the embodiments illustrated in FIG. 7 of the system can be extended to other professionals or groups of users such as, but not limited to, lawyers, real estate agents, financial service advisors, bankers, insurance agents, customer service representatives.

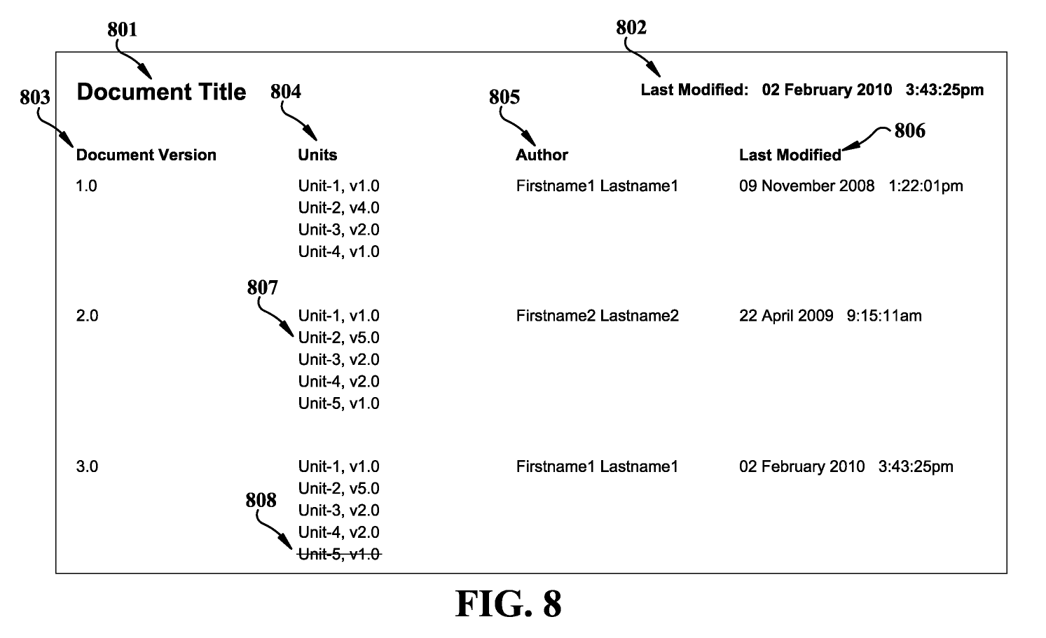

FIG. 8 illustrates an audit trail in which a detailed history (e.g., of a document or other media content) or in other words, a genealogy of content units or documents that can be generated by the reference component 310. For the document represented by the title 801, the field 802 shows when the document was last modified. Columns 803, 804, 805, 806 exemplify an embodiment of document versions, units of contents within the document and their respective versions, author of the document and last modified date and time for the document version, respectively. For example, a tag or reference provided by the reference component 310 can include a genealogy of changes to content units of a set of documents, or a genealogy of changes to documents in general. In one embodiment, a user can hover over or provide input to the system to preview an older version, such as in a bubble, pop-up window or other graphical user interface control. The user can then revert back to the older version for a document if desired.

One aspect of such a representation is that the user is quickly able to see what individual units of content changed across various versions. For example, the user can identify that Unit-2 (807), Unit-4 and Unit-5 were updated as the document under consideration was revised from version 1.0 to version 2.0. Unit-5 (808) was then removed in version 3.0 of the document. In addition, other visual aids such as, but not limited to, comparing document versions and units of contents that have changed, side-by-side with differences clearly highlighted can be added to this interface.

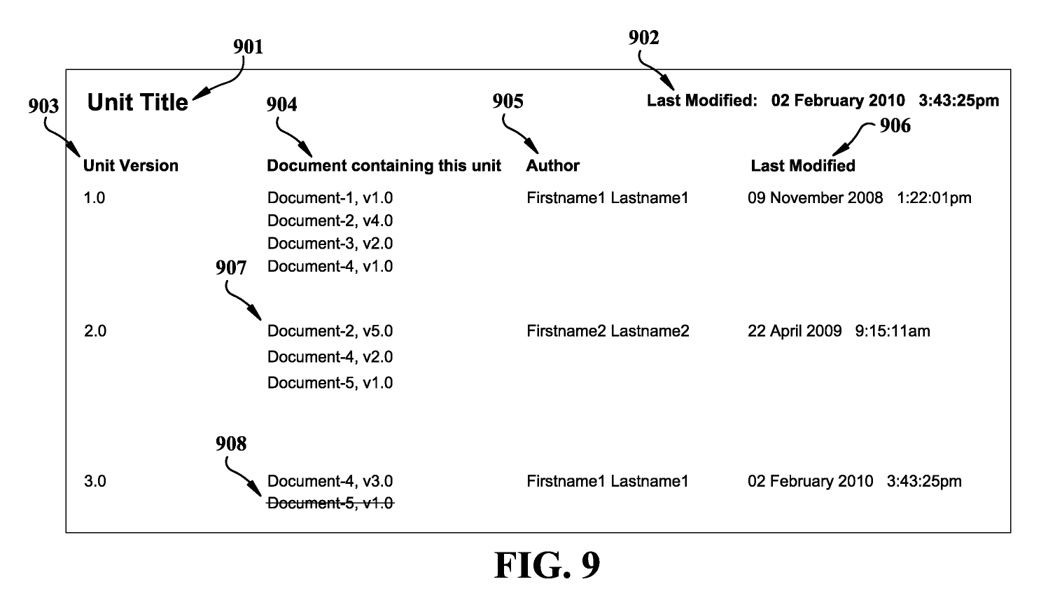

FIG. 9 depicts one way of showing detailed history of a unit of content by an embodiment of the system. For the unit of content represented by the title 901, 902 shows when the unit of content was last modified. Columns 903, 904, 905, 906 exemplify one way of showing unit version, document(s) containing the unit, author of the unit of content and last modified date and time for the version of the unit of content, respectively. One aspect of such a representation is that the user is quickly able to identify which documents along with their versions contain a given version of the unit of content. For example, the user can identify that Document-2 (907), Document-4 and Document-5 received updates when the unit of content under consideration was revised up to version 2.0. Document-1 and Document-3 still contained version 1.0 of the unit of content. When the unit of content was revised up to version 3.0, Document-4 received the updated unit of content. At the same time, the unit of content was deleted from Document-5 (908). In addition, other visual aids such as, but not limited to, comparing document versions and units of contents that have changed, side-by-side with differences clearly highlighted can be added to this interface.

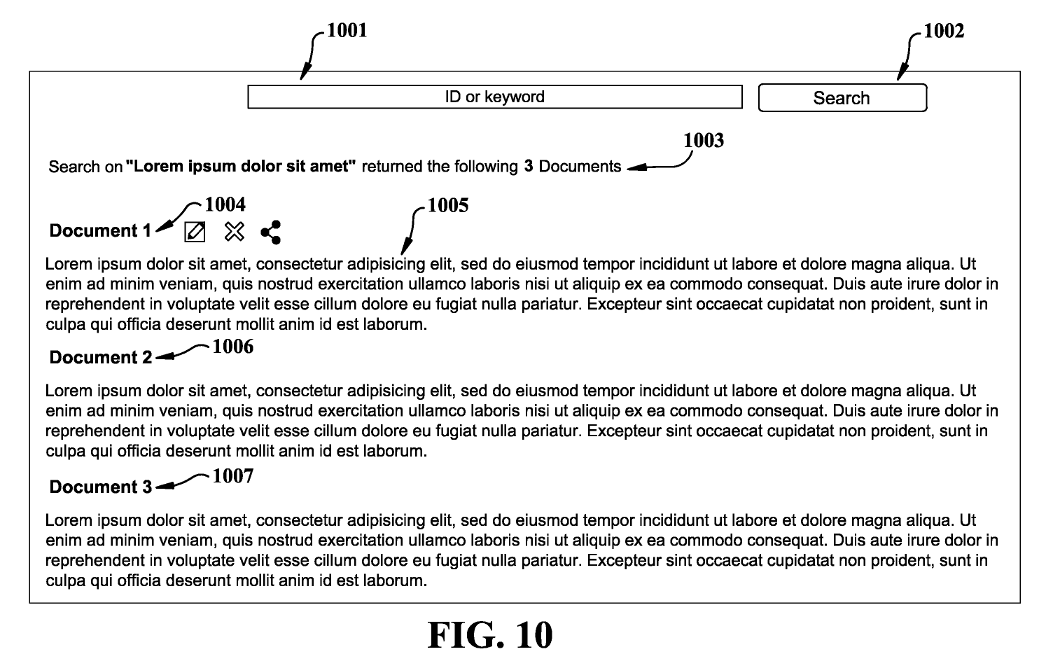

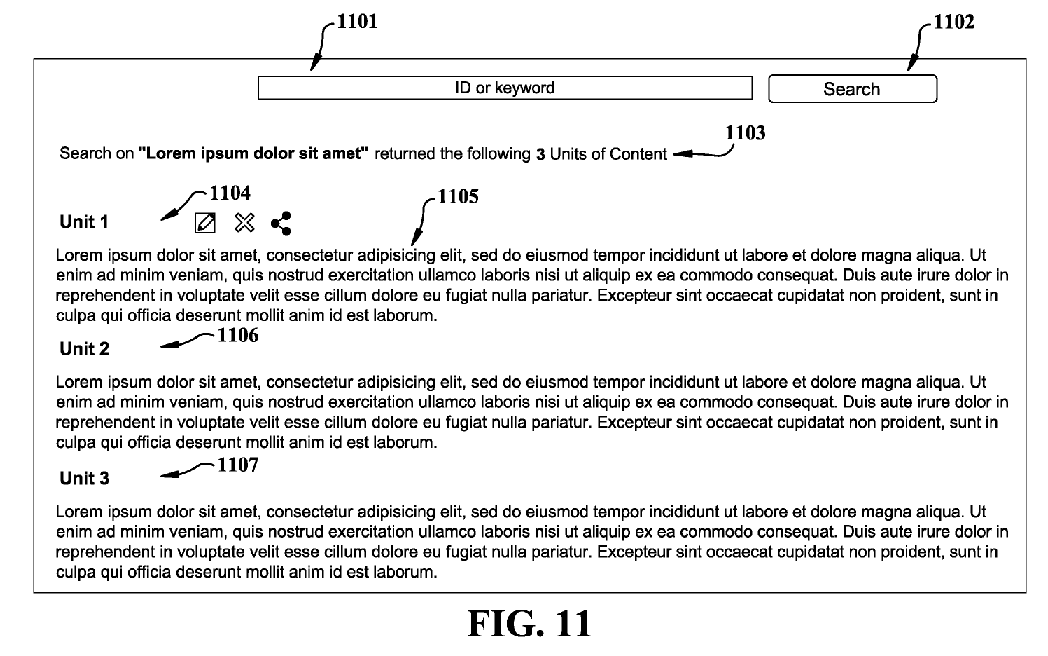

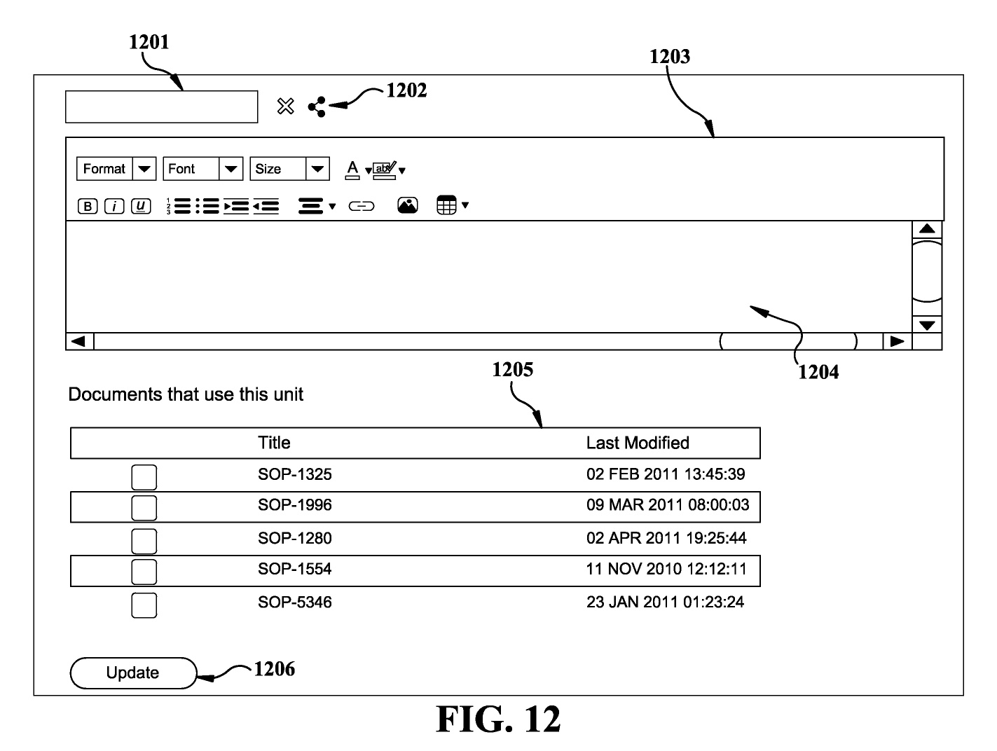

FIG. 10 exemplifies search results served up by the system when a user searches documents and FIG. 11 exemplifies search results served by an embodiment of the system when a user searches for units of content. An embodiment of the suggestion component 110 of the system will display search results with rankings based on aspects such as, but not limited to, keywords, semantics, frequency of use of a unit of content by various users, ranking of the author of the unit of content by the system, trust placed by the user in the author of the unit of content, proximity between the user and the author of the unit of content within a given social and/or professional network, geographical proximity between the user and the author of the unit of content. The system further improves the accuracy and relevance of search results by leveraging the model depicted in FIG. 12 discussed in further detail. One way to use this model for improving search results is to prioritize the results based on the attributes of the unit of content. For example, a unit of content that represents the entire document can be associated with the highest priority, followed by a unit of content associated with a section of a document, followed by that associated with a paragraph and so on.

Searching components 1001 and/or 1101 can search for documents 1003 and/or content units 1103 of documents that making up different sections based on a user setting. Searching can be done in any number of data stores, or memories with a user search input 1002, 1102. Examples of different documents having the searched terms are illustrated as Document 1 (1004), Document 2 (1006) and Document 3 (1007), in which content units 1005 are found to relate to the terms searched or typed in a first view area Likewise, a portion or all of the content units within a related section can be displayed as content units, such as Unit 1 (1104), Unit 2 (1106) and/or Unit 3 (1107), in which the terms can be partially or completely displayed for any given section 1105. A user can further be shown all or a smaller portion of each documents upon the system receiving an input request.

Referring now to FIG. 12, illustrated is an exemplary page for adding and updating a unit of content in an embodiment of the system and pushing the update to the impacted or selected documents. The view component 210 of the system includes viewing area 1203 in which a user can edit, cancel, modify, share, and/or examine a history of documents and/or content units that are included in various sections of the document. For instance, when a user is updating a unit of content or content units associated with “Safety Instructions” in the text area or first view area 1204 of the viewing area 1203, the documents that contain this unit of content are shown in the table or second view area 1205. The user has the option to select all or a few documents to which the updated version of the unit of content will be pushed via a single click of update 1206, or some other user input. The documents that are not selected will not receive the update and retain the older version of the unit of content, and the documents that are updated can be modified and/or referenced with the content from the updated version of the content units or in other words the unit of content.

A reference can provide a list of documents that reference each other at 1202, for example. Thus, a user is able to open a referenced document in a new window, such as in .doc or other formatting for quick research or viewing.

In one embodiment, rather than generating content in a first view area 1204, a user can search for other documents and use content units from one document to be selected as the updated content that will be sent to selected documents within the second view area 1205. It should be noted that the various embodiments described herein are not limited to any specific types of persistent data stores such as a relational database or a key value based database and so on.

Finally, it should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a variety of programming languages such as Assembler, C/C++, perl, shell script, PHP, Java, etc.

While the methods described within this disclosure are illustrated in and described herein as a series of acts or events, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

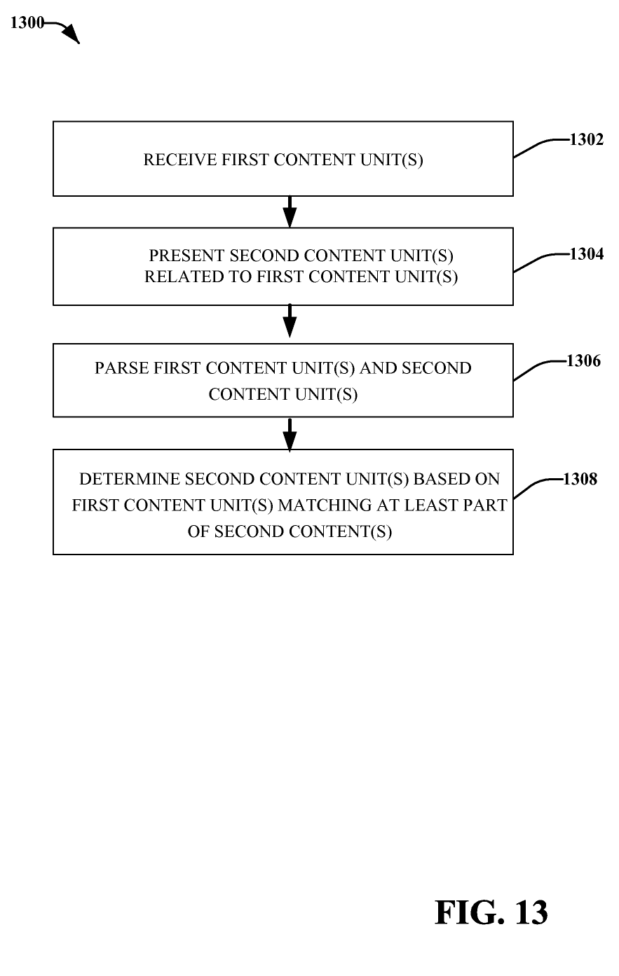

An example methodology 1300 for implementing a method for an efficient document management system is illustrated in FIG. 13. Reference is made to the figures described above for ease of description. However, the methods described herein are not limited to any particular embodiment or example provided within this disclosure.

At 1302, a system receives, by a computer device including at least one processor, a set of first content units of a first document from a user input. The first set of contents can be originating words, text, data that creates a document or a media content including audio, video, digital images, etc. The set of first content units can also be a selected set of content units from an already created media content, such as a document, or a created set of content units created within an already created media content having other content units therein. A set of contents can be a word, words, sentences, paragraphs, sections, headings, titles, and/or any section of a media content (e.g., digital content, video, audio, text, and similar content).

At 1304 a set of second content units (e.g., paragraphs of documents) are presented that are related to the set of first content units based on a set of predetermined criteria and is at least a part of second media content stored in a memory. The set of predetermined criteria can include at least one or more matching words with at least a part of the set of first content units generated by the user input and the second content in other stored second documents. The set of predetermined criteria, for example, can include, but not limited to matching content units of the set of second content units with at least a part of the set of first content units, a position of the set of first content units within the first document (e.g., a title, a subsection heading, conclusion, etc.), a context of the user input based on a subject matter, a section title having at least a part of the set of first content units within a document, a frequency of reuse across different documents of the set of second documents, a percentage of usage of at least a part of the set of first content units within the set of second documents, or metadata associated with the set of first content units. The suggested content units from various sections of documents can therefore be ranked according to their relevancy score by the rating component and sorted according to their rank.

At 1306, includes parsing the set of second content units and the set of first content units of the first media content (e.g., a first document) from a presentation of the first media content. The first media content can be presented in a display, but not saved. The first set of content units, for example, can be a paragraph in which a user types in the creation of a document, or has pasted into a document being created.

At 1308, the method comprises determining the set of second content units that relate to the set of first content units based on first content units of the set of first content units matching at least a part of the set of second content units.

In one embodiment, the method comprises modifying the set of first content units of the first media content, and sharing the updated content units to selected media content of the set of second media content, wherein the set of second media content include different documents that share at least a part of the set of first content units. The modifying is performed independently of storing a duplicate of the set of first content units and the set of second content units. Additionally, the modifying includes making uniform at least a section of the second media content and the set of first content units of the first media content.

representing a document genealogy of the set of first content units of the first media content or the set of second content units of the set of second media content that includes a document, wherein the document genealogy illustrates the one or more content units that changed across different versions of the document; or

In another embodiment, the method comprises representing a content unit genealogy of how the document has been modified across different versions of the document having content units modified. The method includes regenerating a document on demand by combining content units from the presentation of the first media content and other content units of the set of second media content together.

In yet another embodiment, the method comprises suggesting the set of second content units of the second media content in real time according to the set of first content units of the first media content being updated, and receiving a selection for second content units of the set of second content units and modifying second content units selected with the set of first content units or different content units from the set of second content units. The set of first content units is shared by the set of second content units, wherein the set of second content units include paragraphs of a plurality of documents.

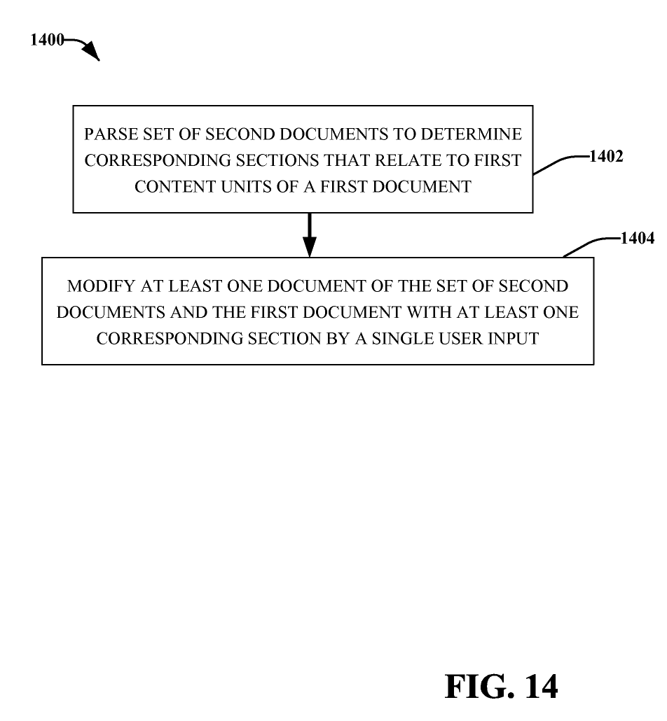

Referring now to FIG. 14, illustrates an exemplary method 1400 for a document management system. The method comprises at 1402 parsing a set of second documents to determine a set of corresponding sections in the set of second documents that relate to content units from a first section of a first document being generated.

At 1404 the method includes modifying at least one document of the set of second documents and the first document with at least one corresponding section by a single user input. For example, two or more documents can be modified simultaneously or at substantially the same time with the same section having the same content units with a single user input. The reference section or section used to modify the one or more documents can be inputted by typing (e.g., a first view area) or selected from among the set of second documents or first documents.

In one embodiment, the set of corresponding sections comprise related paragraphs of the set of second documents to the first section of the first document and the single user input includes a single click, single touch, or single command.

The modifying includes making uniform the first section of the first document and at least one other corresponding section of the set of corresponding sections of the set of second documents.

### Exemplary Networked and Distributed Environments

One of ordinary skill in the art can appreciate that the various embodiments for accessing, searching for, retrieval, modification of documents according to the various embodiments of an efficient document management system described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

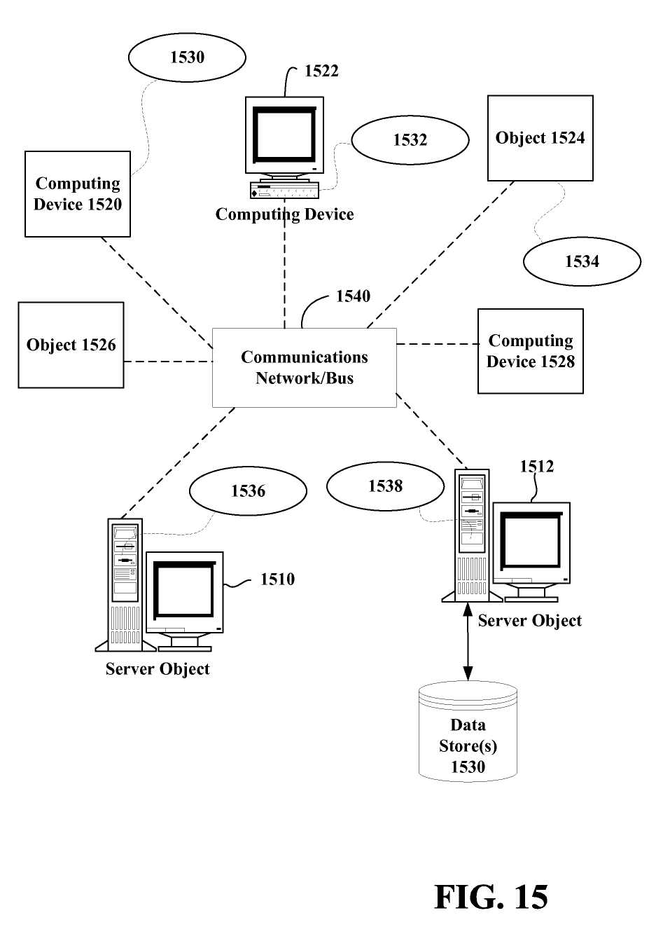

FIG. 15 provides a non-limiting schematic diagram of an exemplary networked or distributed computing environment. The distributed computing environment comprises computing objects or devices 1510, 1512, etc. and computing objects or devices 1520, 1522, 1524, 1526, 1528, etc., which may include programs, methods, data stores, programmable logic, etc., as represented by applications 1530, 1532, 1534, 1536, 1538. It can be appreciated that computing objects or devices 1510, 1512, etc. and computing objects or devices 1520, 1522, 1524, 1526, 1528, etc. may comprise different devices, such as PDAs, audio/video devices, mobile phones, MP3 players, laptops, etc., as well as various software and/or hardware objects supported by a given device.

Computing objects or devices 1510, 1512, etc. and computing objects or devices 1520, 1522, 1524, 1526, 1528, etc. can communicate with one or more other computing objects or devices 1510, 1512, etc. and computing objects or devices 1520, 1522, 1524, 1526, 1528, etc. by way of the communications network 1540, either directly or indirectly. Even though illustrated as a single element in FIG. 15, network 1540 may comprise other computing objects and computing devices that provide services to an embodiment of the system of FIG. 15, and/or may represent multiple interconnected networks, which are not shown. The computing objects or devices 1510, 1512, etc. or 1520, 1522, 1524, 1526, 1528, etc. can also contain an application, such as applications 1530, 1532, 1534, 1536, 1538, that might make use of an application programming interface (API), or other object, software, firmware and/or hardware, suitable for communication with or implementation of document management systems as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as cloud technologies, software as a service, client/server, peer-to-peer, or hybrid architectures, can be utilized. In a client/server architecture, particularly a networked system, a client usually refers to a computer that accesses network resources or services provided by another computer, e.g., a server. In the illustration of FIG. 15, as a non-limiting example, computing objects or devices 1520, 1522, 1524, 1526, 1528, etc. can be thought of as clients and computing objects or devices 1510, 1512, etc. can be thought of as servers where computing objects or devices 1510, 1512, etc. provide data services, such as receiving data from computing objects or devices 1520, 1522, 1524, 1526, 1528, etc., storing of data, processing of data, transmitting data to computing objects or devices 1520, 1522, 1524, 1526, 1528, etc., although any computer can be considered a client, a server, or both, depending on the circumstances. In a peer to peer architecture, typically computing objects or devices 1520, 1522, 1524, 1526, 1528, etc. and computing objects or devices 1510, 1512, etc. interact with one another without classification as servers or clients, since at any given moment, the roles of a given node may change depending on the current functions of the node. Any of these computing devices may be processing data, or requesting services or tasks that may implicate one or more aspects of document management and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to document management can be provided standalone, or distributed across multiple computing devices or objects.

In a network environment in which the communications network/bus 1540 is the Internet, for example, the computing objects or devices 1510, 1512, etc. can be Web servers with which the computing objects or devices 1520, 1522, 1524, 1526, 1528, etc. communicate via any of a number of known protocols, such as HTTP. As mentioned, computing objects or devices 1510, 1512, etc. may also serve as computing objects or devices 1520, 1522, 1524, 1526, 1528, etc., or vice versa, as may be characteristic of a distributed computing environment.

### Exemplary Computing Device

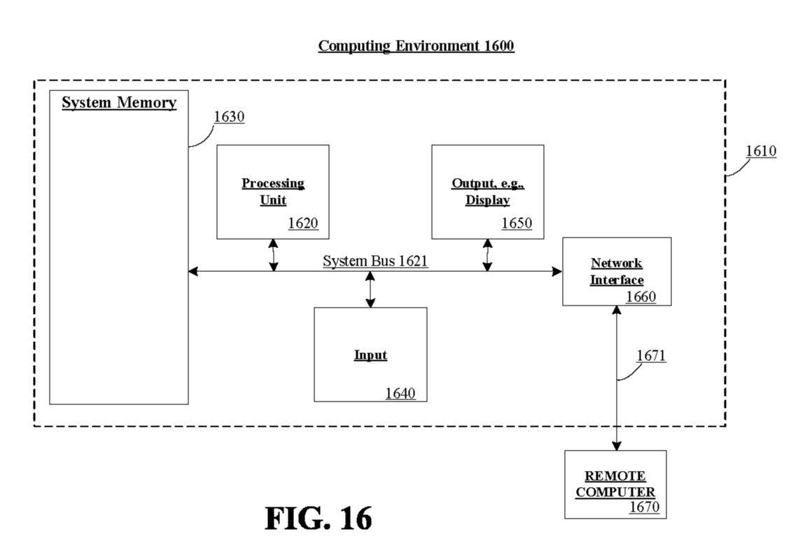

As mentioned, various embodiments described herein apply to any device wherein it may be desirable to manage documents, e.g., as they are modified and proliferate for groups of users. It is understood, therefore, that handheld, portable and other computing devices and computing objects of all kinds are contemplated for use in connection with the various embodiments described herein, i.e., anywhere that a device may provide some functionality in connection with implementing management of documents. Accordingly, the below general purpose remote computer described below in FIG. 16 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 16 thus illustrates an example of a suitable computing system environment 1600 in which one or more of the embodiments may be implemented, although as made clear above, the computing system environment 1600 is only one example of a suitable computing environment and is not intended to suggest any limitation as to the scope of use or functionality of any of the embodiments. The computing environment 1600 is not to be interpreted as having any dependency or requirement relating to any one or combination of components illustrated in the exemplary operating environment 1600.

With reference to FIG. 16, an exemplary remote device for implementing one or more embodiments herein can include a general purpose computing device in the form of a handheld computer 1610. Components of handheld computer 1610 may include, but are not limited to, a processing unit 1620, a system memory 1630, and a system bus 1621 that couples various system components including the system memory to the processing unit 1620.

Computer 1610 typically includes a variety of computer readable media and can be any available media that can be accessed by computer 1610. The system memory 1630 may include computer storage media in the form of volatile and/or nonvolatile memory such as read only memory (ROM) and/or random access memory (RAM). By way of example, and not limitation, memory 1630 may also include an operating system, application programs, other program modules, and program data. In this regard, computer-readable media can be any available media that can be accessed by the computer including removable and non-removable media.

By way of example, and not limitation, computer-readable media can comprise computer storage media and/or communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, Electrically Erasable Programmable Read-Only Memory (EEPROM), flash memory, universal serial bus (USB) drives, or other memory technology, compact disk (CD), digital versatile disk (DVD) or other optical disk storage, magnetic cassettes, magnetic tape, magnetic disk storage, or other magnetic storage devices, or any other medium which can be used to store information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

A user may enter commands and information into the computer 1610 through input devices 1640. A monitor or other type of display device is also connected to the system bus 1621 via an interface, such as output interface 1650. In addition to a monitor, computers may also include other peripheral output devices such as speakers and a printer, which may be connected through output interface 1650.

The computer 1610 may operate in a networked or distributed environment using logical connections to one or more other remote computers, such as remote computer 1670. The remote computer 1670 may be a personal computer, a server, a router, a network PC, a peer device or other common network node, or any other remote media consumption or transmission device, and may include any or all of the elements described above relative to the computer 1610. The logical connections depicted in FIG. 16 include a network 1671, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and memory architectures, the underlying concepts may be applied to any network system and any computing device or storage system in which it is desirable to manage documents.

There are multiple ways of implementing one or more of the embodiments described herein, e.g., an appropriate API, tool kit, driver code, operating system, control, standalone or downloadable software object, executable code, etc. which enables applications and services to use or access the various document management embodiments from any platform. Embodiments may be contemplated from the standpoint of an API (or other software object), as well as from a software or hardware object that facilitates provision of document management in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the various embodiments should not be limited to any single embodiment, but rather should be construed in breadth and scope in accordance with the appended claims.

1. A system, comprising:
a memory that stores computer-executable components;
a processor, communicatively coupled to the memory, that facilitates execution of the computer-executable components, the computer-executable components including:
a suggestion component configured to, in response to reception of a user input that includes a set of first content units of a first document, present a set of second content units that are related to the set of first content units based on a set of predetermined criteria and are at least part of a set of second documents different from the first document; and
a parsing component configured to parse the set of first content units, and determine the set of second content units that relate to the set of first content units based on a first content unit of the set of first content units satisfying at least one predetermined criteria of the set of predetermined criteria.

2. The system of claim 1, further comprising:
a modification component configured to receive modification input that selects which document or documents of the first document and the set of second documents to modify based on the set of second content units.

3. The system of claim 2, wherein the modification component is further configured to modify at least one of the first document or at least one second document of the set of second documents based on the modification input.

4. The system of claim 3, wherein the modification component is further configured to modify the set of first content units to correspond to at least one second content unit of at least one second document associated with the set of second content units, or to modify at least one second content unit of at least one second document associated with the set of second content units to correspond to at least one first content unit of the set of first content units.

5. The system of claim 2, wherein the modification component is further configured to update, with respect to the selected document or documents, the set of second content units to be substantially similar to, or same as, the set of first content units.

6. The system of claim 2, wherein the modification component is further configured to modify the set of second content units with the set of first content units independently of duplicating or copying to a memory any of the set of first content units.

7. The system of claim 1, further comprising:
a user interface component configured to facilitate display of:
a first view area configured to create or edit the first document having the set of first content units; and
a second view area configured to present the set of second content units from the set of second documents in response to the set of first content units being created or edited for the first document in the first view area;
a modification component configured to update the set of second content units of the first view area into the second set of content units in the second view area or update the set of first content units of the first view area with selected second content units of the set of second content units of second view area.

8. The system of claim 7, wherein the second view area is configured to present the set of second content units that are related to the set of first content units based on the set of predetermined criteria and includes at least a part of the set of second documents different from a corresponding part of the first document.

9. The system of claim 8, wherein the user interface component is further configured to receive input relating to at least one subset of second content units of the set of second content units and, in response to the input, generate a set of documents that have the at least one subset of second content units and a set of actions to perform with respect to at least one document of the set of documents.

10. The system of claim 9, wherein the set of actions include propagation of user input to a content unit of the at least one document of the set of documents.

11. The system of claim 1, wherein the set of second content units are presented by the suggestion component based on respective references to respective storage locations of the set of second content units.

12. The system of claim 1, wherein the set of second documents are pre-parsed and indexed before the suggestion component parses the set of first content units.

13. The system of claim 1, wherein the suggestion component is configured to alter the set of second content units being presented in response to a modification of the set of first content units for the first document.

14. The system of claim 1, wherein the set of first content units include at least a part of one or more paragraph sections that correspond to paragraph sections of the set of second documents.

15. The system of claim 1, wherein the set of predetermined criteria includes a match of at least one or more words of the set of second documents with at least a part of the set of first content units generated based on the user input, a match of content units of the set of second content units with at least the part of the set of first content units, a position of the set of first content units within the first document satisfying a condition, a context of the user input based on a determination of subject matter of the user input satisfying a condition, a match of a section title of the set of second documents with a section title of the set of first content units, a relevance score based on one or more of the set of predetermined criteria satisfying a condition, a frequency of reuse across different documents of the set of second documents satisfying a condition, a percentage of usage of at least the part of the set of first content units within the set of second documents satisfying a condition, or a match of metadata associated with the set of first content units with pre-defined metadata.

16. The system of claim 1, further comprising a weighting component configured to weigh a criterion of the set of predetermined criteria according to a setting.

17. The system of claim 1, further comprising a scanning component configured to receive a scan of an image and identify at least a portion of the image as the set of first content units.

18. The system of claim 17, further comprising a view component configured to display the set of second documents and the set of second content units that include sections of the set of second documents that relate to the set of first content units, and wherein the set of first content units are stored in a separate repository of a cloud network from a repository storing at least a part of the set of second documents in the cloud network.

19. The system of claim 1, wherein the set of first content units and the set of second content units respectively include at least one or more words, a paragraph, a document section, a section heading, at least one video unit of video, at least one audio unit of audio, or at least one image segment of images.

20. The system of claim 2, wherein the modification component is further configured to share the set of first content units and the set of second content units based on references to storage within the first document and the set of second documents.

21. The system of claim 1, further comprising a referencing component that identifies different versions of the set of first content units or the set of second content units, or different versions of the first document or the set of second documents, and records a different version with a tag or metadata in a reference to a corresponding content unit or a corresponding document.

22. The system of claim 21, wherein the tag or the reference includes a genealogy of changes to the corresponding content unit, or a genealogy of changes to the corresponding document.

23. The system of claim 1, wherein the suggestion component is further configured to create the first document based on the set of second content units being presented, wherein the set of first content units comprise a section with paragraphs, a paragraph, a sentence, or heading with more than one word of a document.

24. The system of claim 1, further comprising a rating component configured to measure a relevancy score of the set of second content units according to at least one of the set of predetermined criteria.

25. The system of claim 2, further comprising:
a pricing component configured to determine a cost or receive a payment related to an authorship and a number of selected documents of the set of second documents to be modified.

26. A system, comprising:
a view component comprising:
a first view area configured to create or edit a first document having first content units;
a second view area configured to present second content units dynamically from one or more second documents different from the first document in response to the first content units being created or edited for the first document in the first view area;
a modification component configured to receive a modification input that selects which of the first document or the one or more second documents to modify, and to modify at least one selected document of the first document or the one or more second documents based on the first content units or the second content units.

27. The system of claim 26, wherein the presented second content units include at least a part of paragraphs from the one or more second documents that relate to the generated content units, the first content units and the second content units including one or more of digital images, words, numbers, characters and symbols.

28. The system of claim 26, wherein the modification component is further configured to generate sections of the first document from selected second content units of the one or more second documents.

29. The system of claim 26, wherein the modification component is further configured to generate one or more uniform sections of content units among the at least one selected document based on selected content units of the second content units.

30. The system of claim 26, further comprising a reference component configured to generate references to a modified section of the at least one selected document based on metadata related to a modification of the modified section via the modification component.

31. The system of claim 30, wherein the reference component is further configured to identify different versions of the first content units or the second content units and record the different versions with tags or the references based on the metadata to the modified section.

32. A method, comprising:
receiving, by a system including at least one processor, a set of first content units of a first media content from input to the system via a user interface;
presenting, in response to the receiving the set of first content units, a set of second content units of a set of second media content different than the first media content that are related to the set of first content units based on a set of predetermined criteria and are at least a part of second media content stored in at least one memory; and
parsing the set of first content units of the first media content, and
determining the set of second content units that relate to the set of first content units including determining first content units of the set of first content units satisfying at least one of predetermined criteria of the set of predetermined criteria.

33. The method of claim 32, further comprising:
modifying the set of first content units of the first media content; and
sharing the set of modified first content units to selected media content of the set of second media content, wherein the set of second media content include different documents that share at least a part of the set of first content units.

34. The method of claim 33, wherein the modifying is performed independently of storing a copy of or duplicating the set of first content units and further copying of the set of second content units.

35. The method of claim 34, wherein the modifying includes making uniform at least a section of the set of second media content and the set of first content units of the first media content.

36. The method of claim 32, further comprising:
representing a document genealogy of the set of first content units of the first media content or the set of second content units of the set of second media content that includes a document, wherein the document genealogy illustrates content units that changed across different versions of the document; or
representing a content unit genealogy of how the document has been modified across different versions of the document having content units modified.

37. The method of claim 32, further comprising:
regenerating a document by request including combining the set of first content units from the first media content and other content units of the set of second media content together.

38. The method of claim 32, further comprising:
suggesting the set of second content units of the set of second media content according to the set of first content units of the first media content being updated; and
receiving a selection for second content units of the set of second content units and modifying second content units selected with the set of first content units or different content units from the set of second content units.

39. The method of claim 32, wherein the set of first content units is shared by the set of second content units, and the set of second content units include paragraphs of a plurality of documents.

40. The method of claim 32, wherein the set of predetermined criteria includes a match of at least one or more words of a set of second documents with at least a part of the set of first content units generated based on a user input, a match of content units of the set of second content units with at least the part of the set of first content units, a position of the set of first content units within the first document satisfying a condition, a context of the user input based on a determination of subject matter of the user input satisfying a condition, a match of a section title of the set of second documents with a section title of the set of first content units, a relevance score based on one or more of the set of predetermined criteria satisfying a condition, a frequency of reuse across different documents of the set of second documents satisfying a condition, a percentage of usage of at least the part of the set of first content units within the set of second documents satisfying a condition, or a match of metadata associated with the set of first content units with pre-defined metadata.

41. A computer readable storage medium comprising computer executable instructions that, in response to execution, cause a computing system including at least one processor to perform operations, comprising:
parsing a set of second documents to determine a set of corresponding sections in the set of second documents that relate to content units from a first section of a first document; and
modifying at least one document of set of documents and the first document with at least one corresponding section of the set of corresponding sections by a single user input.

42. The computer readable storage medium of claim 41, wherein the set of corresponding sections comprise related paragraphs of the set of second documents to the first section of the first document and the single user input includes a single click, single touch, or single command.

43. The computer readable storage medium of claim 41, wherein the modifying includes making uniform the first section of the first document and at least one other corresponding section of the set of corresponding sections of the set of second documents.

44. A system comprising:
means for creating or editing a first document including means for presenting at least respective parts of content units from a set of second documents that relate to a content unit being generated or edited for the first document; and
means for sharing selected content units between the at least the respective parts of content units and the first document.

45. The system of claim 44, further comprising:
means for selecting one or more of the at least a part of content units for editing simultaneously with content units being generated for the first document.

46. The system of claim 45, further comprising:
means for modifying or adding to the content units being generated for the first document with one or more selected content units of the set of second documents.

47. The system of claim 41, wherein each content unit includes a paragraph or a subsection of the first document or the set of second documents respectively.
